(19) United States
(12) Patent Application Publication
(10) Pub. No.: US 2020/0276883 A1
(43) Pub. Date: Sep. 3, 2020

(54) AIR CONDITIONING SYSTEM FOR VEHICLES

(71) Applicant: AUTOCLIMA S.P.A., Cambiano (IT)

(72) Inventor: Matteo GUERCIO, Orbassano (IT)

(73) Assignee: AUTOCLIMA S.P.A., Cambiano (IT)

(21) Appl. No.: 16/762,964

(22) PCT Filed: Nov. 17, 2017
(86) PCT No.: PCT/IT2017/000259

§ 371 Date: May 11, 2020

(51) Int. Cl. B60H 1/32; B60H 1/00

(52) U.S. Cl. CPC B60H 1/323; B60H 1/00428; B60H 1/00364; B60H 1/3227; B60H 1/00735

(57) ABSTRACT

An air conditioning system for vehicles, which comprises a closed circuit affected at least by a primary compressor actuated directly or indirectly by the engine of the vehicle, by a primary condenser and by an evaporator, all of which can be passed through in sequence by a heat carrier fluid that circulates in the circuit, for the execution, with engine running, of a primary refrigeration cycle, the closed circuit connected to a branch arranged parallel to the primary compressor and affected by an electric auxiliary compressor, the branch can be passed through by the heat carrier fluid for the execution, with engine switched off, of an auxiliary refrigeration cycle, the system comprises an electronic control and management unit configured to assign the auxiliary compressor an operating mode composed of predefined alternating intervals of power-on and power-off; during each power-on interval the auxiliary compressor operates at a preset rotation speed value.

The present invention relates to an air conditioning system for vehicles.

As is well known, most vehicles are provided with a preinstalled air conditioning (or climate control) system, which is connected to the internal combustion engine of the vehicle proper and is intended to ensure better environmental conditions for the driver.

More precisely, a system of the type described above can execute a refrigeration cycle and it is therefore made up of at least a compressor, an evaporator, a condenser and a dehydrating filter. The compressor is entrained in rotation, via a belt, by the engine (which therefore is responsible for supplying the work necessary for the cycle). The evaporator is arranged inside the vehicle, to remove heat and ensure better environmental conditions.

The condenser is located outside, and usually it is cooled with the fan of the radiator.

A system of the type described above is evidently designed to operate only when the vehicle is in motion, in that, as has been seen, it is actuated by the internal combustion engine that entrains the compressor in rotation.

While this limitation is not viewed as such by a segment of the reference market, it does in fact constitute an increasingly undesirable, and often unacceptable, drawback for a significant segment of customers, which for example make professional use of the vehicles, such as trucks, semi-trailer trucks and the like.

In fact, the drivers of such vehicles often make long stops while driving, to rest or even sleep in the cabin of the vehicle. During stops of a different nature, made by other types of vehicles (security vans for example), the need is still felt to control the climate of an internal compartment in a similar manner, because it is occupied by one or more individuals.

The need is therefore felt to control the environmental conditions of the cabin or in any case of the compartment, as occurs during the movement of the vehicle, but such need cannot be met by the system described above, because the engine is switched off.

In order to overcome the limitation described above, makers of vehicles have therefore offered solutions on the market whereby the factory-installed air conditioning system is provided with an integrated parallel circuit, provided with an auxiliary compressor powered by an energy source independent of the engine, and which typically is constituted by the battery of the vehicle, or by an additional electric storage cell. In this way, evidently the system is capable of operating when the engine is switched off, thereby ensuring the wellbeing of the driver or in any case of whoever remains in the vehicle even when it is parked.

Such implementation solutions are also not devoid of drawbacks, however.

In fact, independently of the specific type of energy source adopted, it still offers a limited availability of energy, which not infrequently is insufficient to power the auxiliary compressor optimally. It should be noted in fact that for structural reasons electric auxiliary compressors cannot operate at low RPM, since otherwise the fluid that executes the cycle and which in such devices also has the function of cooling the electric motor with which they are provided would not succeed in accomplishing this further function. This forces makers to have compressors operate at high RPM, which however consumes great quantities of electricity, thus coming into conflict with the availability limitations noted previously.

It should be noted moreover that a high demand for energy from the auxiliary compressor can result in the total depletion of the energy available in the battery of the vehicle, when the compressor is associated with the battery, requiring further countermeasures and contrivances in order to prevent such an eventuality.

The aim of the present invention is to solve the above mentioned problems, by providing a system that is provided with an auxiliary compressor that operates when the internal combustion engine is switched off, and which requires a low energy consumption while ensuring an adequate yield.

Within this aim, an object of the invention is to provide an auxiliary compressor for air conditioning systems of vehicles, which requires a low energy consumption while ensuring an adequate yield.

Another object of the invention is to provide a system in which the auxiliary compressor, designed to operate with the engine switched off, ensures an adequate operation even with a reduced availability of energy for its power supply.

Another object of the invention is to provide a system in which the auxiliary compressor, designed to operate with the engine switched off, can be adequately powered by the battery of the vehicle on which the system proper is installed.

Another object of the invention is to provide a system that ensures a high reliability of operation.

Another object of the invention is to provide a system that adopts an alternative technical and structural architecture to those of conventional systems.

Another object of the invention is to provide a system that can be easily implemented using elements and materials that are readily available on the market.

A still further object of the invention is to provide a system that is low cost and safely applied.

This aim and these and other objects which will become better apparent hereinafter are achieved by a system according to claim 1 and by a compressor according to claim 9.

Further characteristics and advantages of the invention will become better apparent from the detailed description that follows of a preferred, but not exclusive, embodiment of the system according to the invention, which is illustrated by way of non-limiting example in the accompanying drawings, wherein:

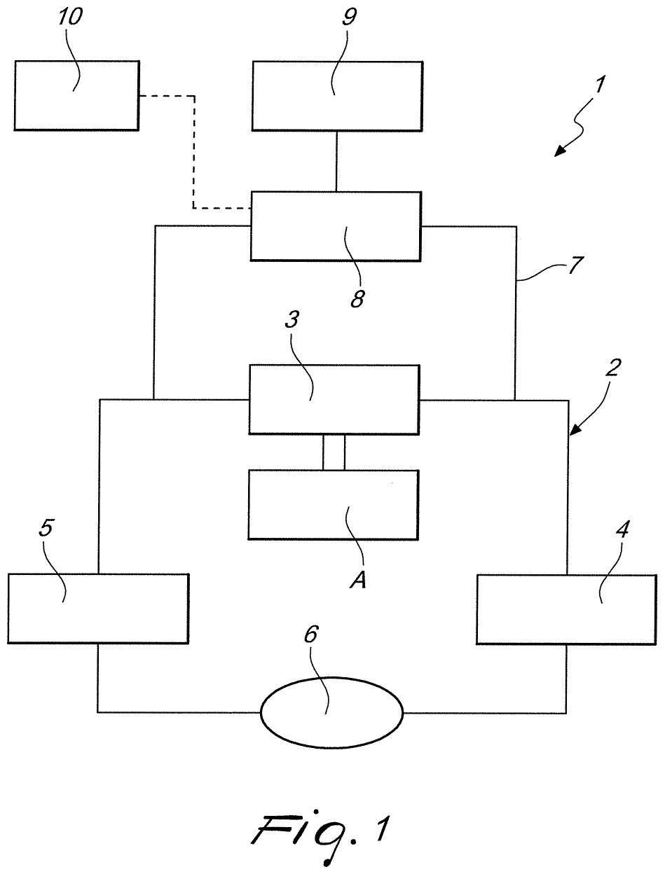

FIG. 1 is a block diagram of the system according to the invention;

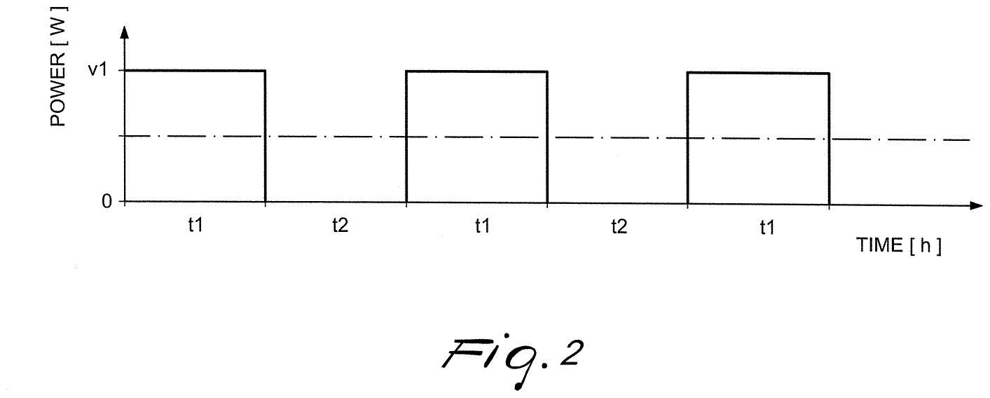

FIG. 2 is a graph of a possible operating mode of the auxiliary compressor.

With particular reference to the figures, the reference numeral 1 generally designates an air conditioning system (or climate control system) for vehicles, of various types.

According to methods that are known per se, such system 1 comprises a closed circuit 2, in which a heat carrier fluid circulates by virtue of which the system 1 first of all (cyclically) executes a primary refrigeration cycle, so as to ensure better environmental conditions (in terms of temperature, humidity etc.) inside a compartment of the vehicle (the cabin or driver's cab or the like).

More precisely, the closed circuit 2 is affected at least by a primary compressor 3, which as needed can be actuated directly or indirectly by the engine A of the vehicle (for example by way of a belt), by a primary condenser 4 and by an evaporator 5.

The engine A is what provides propulsion to the vehicle, and typically, but not exclusively, it is an internal combustion engine.

The primary compressor 3, the primary condenser 4 and the evaporator 5 can be passed through in sequence by the heat carrier fluid that circulates in the circuit 2, in order to execute, with the engine A running, the primary refrigeration cycle.

It should be noted that in order to allow the execution of the primary refrigeration cycle, the condition that the engine A is running is necessary, since it is the latter that turns the primary compressor 3.

In any case, the methods that the system 1 uses to perform the primary refrigeration cycle are in and of themselves well known and therefore they are not described further in this discussion. It should be noted in any case that typically such primary refrigeration cycle lowers the temperature and/or humidity of a compartment of the vehicle (passenger compartment or driver's cab); however, the possibility is not ruled out of operation in reverse, as a heat pump.

The system 1 can therefore be completed with other components and elements, such as those that the person skilled in the art would be able to choose in order to enable the optimal execution of the primary refrigeration cycle.

For example, the circuit 2 is usually also affected by a dehydrating filter 6, interposed between the primary condenser 4 and the evaporator 5, as can be seen in the accompanying FIG. 1.

The closed circuit 2 is connected to a branch 7; the branch 7 is arranged parallel to the primary compressor 3 and is affected by an electric auxiliary compressor 8. The auxiliary compressor 8 can be powered with an electric power source 9 that is independent of the engine A of the vehicle, so as to be able to operate in the absence of energy from the engine A proper (and therefore, when the latter is switched off). What is meant by independent energy source 9 is that it is separate from the engine A and that it is capable of dispensing energy even when the latter is switched off: for example it can coincide with the battery of the vehicle (the one used to start the engine A). Alternatively, the system 1 can comprise an energy source 9 that is separate from the battery of the vehicle, for example constituted by an additional accumulator battery (or the like).

The branch 7 can also be passed through by the heat carrier fluid (as an alternative to the portion of circuit 2 parallel thereto, and which contains the primary compressor 3), so as to execute, with the engine A switched off, an auxiliary refrigeration cycle.

It should be noted that execution of such auxiliary refrigeration cycle still draws on much of the circuit 2, and in particular the primary condenser 4 and the evaporator 5 (and the filter 6) described previously, limiting itself in fact to using the auxiliary compressor 8, which is powered independently by the energy source 9, in place of the primary compressor 3. During the execution of the auxiliary refrigeration cycle the system 1 is also intended to be predominantly used as a cooling machine for removing heat (lowering the temperature and/or humidity); again, the possibility is not ruled out however of use in reverse, as a heat pump.

It should be noted from this point onward that in the principal application the system 1 that is the subject matter of the present discussion is intended to be installed on heavy vehicles for professional use, such as trucks, semi-trailer trucks and the like, in order to enable control of the environmental conditions in the cabin both when the engine A is running (during the movement of the vehicle) and when the engine A is switched off. In this latter condition, the drivers of such vehicles can therefore benefit from the presence of the auxiliary compressor 8 to enjoy adequate environmental conditions during the long stops that they make, resting or sleeping inside the cabin proper.

Typically, the system 1 described up to this point is supplied by the maker as an integrated solution already fitted when the vehicle is sold, but the protection should be understood to be extended to the provision of systems 1 of such nature by way of subsequent installation of an auxiliary compressor 8 (which operates with the engine A switched off) on a preexisting circuit 2, which operates solely with the engine A switched off.

Furthermore, the scope of protection claimed herein 1 comprises other kinds of vehicles and/or other situations in which the engine A is in any case switched off. For (non-limiting) example, in an additional application the system 1 can be installed on security vans, which also make long stops for loading and/or unloading the cargo compartment. In this case therefore, it is the cargo compartment (in addition optionally to the passenger compartment or driver's cab) that is affected by the twofold action of the system 1 (or at least by the action with the engine A switched off).

It should be noted in any case that other applications of the system 1 are not ruled out, for controlling the environmental conditions of passenger compartments, driver's cabs, cargo compartments or other vehicle compartments of all types. For example in fact, the system 1 can provide air conditioning when the engine A is running or switched off on works vehicles (reach trucks, earth-moving machines etc.) or even on completely different vehicles, such as ships or the like.

Alternatively, the system 1 can be installed on automobiles with internal combustion engine A or electric engine A, etc.

According to the invention, the system 1 comprises an electronic control and management unit 10, which is configured to assign a peculiar operating mode to the auxiliary compressor 8.

It should be noted that the electronic unit 10 can be installed on the auxiliary compressor 8 or be separate from it, and in any case it can be a controller, an electronic computer or the like, according to the specific requirements.

In any case, such operating mode (illustrated schematically in FIG. 2) is composed of predefined alternating intervals of power-on and power-off t1, t2. Hereinbelow and in the graph in FIG. 2, the power-on intervals are designated with t1, while the power-off intervals are designated with t2.

During each power-on interval t1 the auxiliary compressor 8 operates at a preset rotation speed value v1.

The alternation of powering up and powering down thus makes it possible to achieve the set aim: it should be noted in fact that (electric) auxiliary compressors 8 of the type intended to be part of the system 1 usually cannot operate at a low number of revolutions (at a low rotation speed), owing to structural limitations already explained in the foregoing pages. By contrast, a low number of revolutions would be appreciated in order to allow limited consumption, in line with the limited availability of electricity usually ensured by the battery of the vehicle or by an additional, independent source 9.

Therefore, the invention ensures reduced consumption by alternating power-on intervals t1 with power-off intervals t2, so as to obtain, with the average value (shown by a dot-dash line in FIG. 2), a behavior comparable (in terms of consumption) to that obtainable with a low value of number of revolutions, although without ever operating directly at such average value. At the same time, the periodic shutdown of the auxiliary compressor 8 does not compromise optimal operation in that the air conditioning provided during the power-on intervals t1 is in any case sufficient to ensure the desired wellbeing in the compartment of interest (passenger compartment, driver's cab or the like).

The possibility is not ruled out however of providing systems 1 according to the invention, remaining within the scope of protection claimed herein, which are provided with auxiliary compressors 8 of any type (therefore possibly designed to operate at a low number of revolutions), while still operating according to such operating mode.

In a first implementation of the invention, the preset rotation speed value v1 is chosen to correspond to the maximum energy efficiency of the auxiliary compressor 8.

In this regard, it should be noted that usually the rotation speed that corresponds to the maximum energy efficiency is equal to the average of the minimum and maximum speeds permitted, and is in any case usually made known by the maker of the auxiliary compressor 8, who supplies a graph that shows the variation of the efficiency with the variation of the rotation speed.

Therefore if the system 1 is already preinstalled on the vehicle in all its parts, it can be supplied with an electronic unit 10 that is already preconfigured with the preset value v1, just as the auxiliary compressor 8 and the unit 10 can be subsequently installed since the latter is already in possession of such information.

In any case, it should be noted that it is possible to identify the rotation speed that corresponds to the maximum energy efficiency simply by making the auxiliary compressor 8 operate at various numbers of revolutions (at least two), in each situation measuring the cooling power dispensed and the power consumed. The ratio between such values is known as the coefficient of performance (COP) and is the energy efficiency of interest.

Purely for the purposes of example it should be noted that for an auxiliary compressor 8 that operates between 50 rpm and 100 rpm, the preset value v1 often coincides with 75 rpm.

In a different implementation of the invention, the preset rotation speed value v1 is chosen to correspond to the minimum rotation speed specified for the auxiliary compressor 8. Returning therefore to the example of the previous paragraph (purely for the purpose of non-limiting example), in such solution the preset value v1 is equal to 50 rpm.

It should be noted that the possibility is not ruled out of choosing the preset value v1 in another way, just as it is possible to use electronic units 10 that can leave it to the user to freely choose (between two or more options) the preset value v1 at which to make the auxiliary compressor 8 turn in the power-on intervals t1.

Conveniently, the alternating intervals of power-on and power-off t1, t2 are chosen to be of equal duration. This makes it possible to optimally balance the need to keep consumption down with the goal of ensuring in any case an adequate yield of the auxiliary compressor 8 and of the system 1 in general.

So assuming a work time of one hour, if this is divided into 6 identical intervals of 10 minutes each, cyclically one passes from a cooling power equal for example to 2000 Watts (at the optimal rotation speed value) to one equal to 0 Watts. In this way a total cooling power equal to 1000 Watt/h is obtained, i.e. half of the power produced.

In the preferred embodiment, cited by way of non-limiting illustration of the application of the invention, the auxiliary compressor 8 is of the direct current type. In this manner, the auxiliary compressor 8 can be powered by the battery of the vehicle, which is used for the ignition of its engine A, and this evidently makes it possible to keep down the number of components necessary for the operation of the system 1.

With further reference to the preferred, but not limiting, embodiment, the unit 10 is associated with a control panel, so as to enable a user to freely manage and reprogram the duration of the intervals t1, t2, of the preset rotation speed value v1 (as mentioned earlier in the previous paragraphs) and/or of other operating parameters.

Conveniently, the system 1 according to the invention comprises an auxiliary condenser, which is arranged downstream of the auxiliary compressor 8 and which can be arranged in series with the primary condenser 4. Obviously, the auxiliary condenser can also be passed through by the heat carrier fluid and it can therefore perform the role of the primary condenser 4 in order to make the heat carrier fluid perform the auxiliary refrigeration cycle, when the motor A of the vehicle is switched off.

Conveniently, the system 1 according to the invention comprises at least one auxiliary fan (and preferably a pair of auxiliary fans), powered by the source 9 of electric power (be it the battery of the vehicle, another device included in the system 1, or the like). The auxiliary fan (or each auxiliary fan) can be arranged proximate to the primary condenser 4, so as to cool it even when the engine A is switched off. If the system 1 also comprises an auxiliary condenser, the fan (or each fan) can be arranged proximate to the latter, in order to cool it.

It should be noted that conventional air conditioning systems are provided with viscostatic fans (especially for heavy vehicles, as in the preferred application of the invention), which are actuated by the engine A and which increase their speed only in the event of an increase in the temperature of the engine A proper. In addition to a fan of this type (which cannot be used when the engine A is switched off), the system 1 according to the invention can in fact have one or more auxiliary fans, in order to obtain the ventilation even when the vehicle is stationary, powered by the energy source 9. In this regard, it should likewise be noted that the speed of the auxiliary fans is controlled as a function of the pressure measured by a pressure switch fitted on the auxiliary compressor 8.

As has been seen, the scope of protection claimed herein relates to systems 1 that are already preinstalled on the vehicle, but also to systems 1 obtained by later connecting additional components (for the execution of the auxiliary refrigeration cycle) on a preinstalled closed circuit 2 that is provided with the components for executing the primary refrigeration cycle alone.

Therefore this discussion (and the protection claimed herein) also relates to an electric auxiliary compressor 8, adapted to be connected to a closed circuit 2 in order to provide an air conditioning system 1 of the type described up to this point. According to the invention therefore, such auxiliary compressor 8 comprises an electronic control and management unit 10 according to what is described up to this point.

Operation of the system according to the invention is therefore evident from the discussion given in the foregoing pages.

When the engine A of the vehicle is started, the system 1 operates in the traditional manner, with the heat carrier fluid which, in the closed circuit 2, passes in series through the primary compressor 3, the primary condenser 4, the filter 6 and the evaporator 5, in order to execute the primary refrigeration cycle with which to improve the climate conditions in the cabin of the vehicle, or other compartment.

Likewise, when the engine A is switched off the auxiliary compressor 8 substitutes the primary compressor 3 (and optionally the auxiliary condenser substitutes the primary condenser 4), in order to execute the auxiliary refrigeration cycle with the engine A switched off, and therefore ensure more favorable climate conditions in the same environment when the vehicle stops, for a time more or less prolonged.

As already anticipated, the peculiar operating mode assigned by the unit 10 to the auxiliary compressor 8 enables the system 1 to operate with a low energy consumption while still ensuring an adequate yield.

It has in fact already been observed that by alternating power-off intervals t2 with power-on intervals t1 (in which the auxiliary compressor 8 operates at a preset rotation speed value v1), it is possible to “simulate” a behavior with a low number of revolutions (the average between v1 and 0, weighted on the duration of the respective intervals t1, t2), which cannot be obtained directly. This in fact makes it possible to require low quantities of energy of the source 9, and therefore to obtain a correct operation even if this energy source has limited availability. Obviously this is valid for any energy source 9 chosen, be it the battery of the vehicle (in such case preferably the electric auxiliary compressor 8 is DC) or another source.

At the same time, by virtue of the power-on intervals t1 in which the auxiliary compressor 8 operates at the preset value v1, the system 1 still ensures a practically optimal yield, ensuring in fact, even when parked, pleasant climate conditions inside the compartment of interest (passenger compartment, driver's cab or the like).

The control panel likewise makes it possible to manage and reconfigure the unit 10 at will (optionally the unit is chosen independently of the apparatus responsible for the control of the primary compressor 3 and for the other functions of the vehicle), thus ensuring greater versatility and practicality of use for the invention.

It should be noted finally that the electronic unit 10 can be pre-set to automatically disable the auxiliary compressor 8 when the ignition key is rotated completely (or even only when it is partially rotated, in order to bring it to the position known as “+key”, which usually activates the electrical system of the vehicle). This evidently is in order to ensure that the auxiliary compressor 8 is not activated with the engine A running or indeed with the vehicle in motion (when the primary compressor 3 will be used). This also makes it possible to optimize the energy consumption of the vehicle.

The invention thus conceived is susceptible of numerous modifications and variations, all of which are within the scope of the appended claims. Moreover, all the details may be substituted by other, technically equivalent elements.

In the embodiments illustrated, individual characteristics shown in relation to specific examples may in reality be substituted with other, different characteristics, existing in other embodiments.

In practice, the materials employed, as well as the dimensions, may be any according to requirements and to the state of the art.

1.-9. (canceled)

10. An air conditioning system for vehicles, which comprises a closed circuit affected at least by a primary compressor configured to be actuated directly or indirectly by the engine of the vehicle, by a primary condenser and by an evaporator, all of which can be passed through in sequence by a heat carrier fluid that circulates in said circuit, for the execution, with the engine running, of a primary refrigeration cycle, said closed circuit being connected to a branch arranged parallel to said primary compressor and affected by an electric auxiliary compressor, which is configured to be powered with an energy source of electric power independent of the engine of the vehicle, said branch being adapted to be passed through by the heat carrier fluid for the execution, with the engine switched off, of an auxiliary refrigeration cycle, and further comprising an electronic control and management unit configured to assign said auxiliary compressor an operating mode that is composed of predefined alternating intervals of power-on and power-off, during each power-on interval said auxiliary compressor operating at a preset rotation speed value.

11. The system according to claim 10, wherein said preset rotation speed value is chosen to correspond to a maximum energy efficiency of said auxiliary compressor.

12. The system according to claim 10, wherein said preset rotation speed value is chosen to correspond to a minimum rotation speed specified for said auxiliary compressor.

13. The system according to claim 10, wherein said alternating intervals of power-on and power-off are chosen to be of equal duration.

14. The system according to claim 10, wherein said electronic control and management unit is associated with a control panel, for a free management and reprogramming of a duration of said intervals, of said preset rotation speed value and/or of other operating parameters.

15. The system according to claim 10, wherein said auxiliary compressor is of the direct current type.

16. The system according to claim 10, further comprising an auxiliary condenser, which is arranged downstream of said auxiliary compressor and which is arranged in series with said primary condenser.

17. The system according to claim 10, further comprising at least one auxiliary fan, which is powered by said energy source and is arranged proximate to said primary condenser for a cooling thereof even with the engine switched off and/or proximate to said auxiliary condenser, for the cooling thereof.

18. An electric auxiliary compressor, configured to be connected to a closed circuit for providing an air conditioning system according to claim 10.
